(19) United States
(12) Patent Application Publication
(10) Pub. No.: US 2014/0196670 A1
(43) Pub. Date: Jul. 17, 2014

(54) Animal Self-Grooming Device

(71) Applicant: Cynthia Lamers, Arrowwood (CA)

(72) Inventor: Cynthia Lamers, Arrowwood (CA)

(21) Appl. No.: 13/740,300

(22) Filed: Jan. 14, 2013

(51) Int. Cl. A01K 13/00

(52) U.S. Cl. CPC A01K 13/004
USPC 119/621

(57) ABSTRACT

An animal self-grooming device includes a rectangular sheet of flexible material that has an interior surface and an exterior surface. The rectangular sheet is rolled into a generally tubular-shaped enclosure that is open at opposite ends and includes a longitudinally extending seam. A plurality of bristles or tuffs is affixed to the rectangular sheet substantially along the interior surface. A pair of flexible securement band encircles the rectangular sheet about the exterior surface and has opposed ends that are secured to the rectangular sheet at opposite edges of the seam so as to prevent separation of the seam. A tubular sheath encircles the rectangular sheet and the first and second flexible securement bands. The tubular sheath has opposed open ends that cooperatively align with the opposite open ends of the rectangular sheet.

### FIELD OF THE INVENTION

The present invention relates generally to animal grooming, and more particularly, relating to an animal grooming device that permits an animal to self-groom.

### BACKGROUND OF THE INVENTION

There exist many devices that permit self-grooming by an animal that are designed to solve the readily known hair and debris problem associated with keeping animals indoors. These devices seek to provide alternative opportunities for an animal to self-groom other than the undesired use of home furnishings. While the devices heretofore meet their respective objective an requirements, there remains a need for an animal self-grooming device of an improved construction that is easy to operate and is of a simplified construction.

### SUMMARY OF THE INVENTION

The embodiments of the present invention addresses this need by providing an animal self-grooming device that is broadly of a tubular design constructed from a sheet of flexible material that is rolled and held in the rolled configuration. The interior of the sheet material is tufted or includes bristles that groom an animal's coat as the animal passes through the tube.

To achieve these and other advantages, in general, in one aspect, an animal self-grooming device is provided. The device includes a rectangular sheet of flexible material that has an interior surface and an exterior surface. The rectangular sheet is rolled into a generally tubular-shaped enclosure that is open at opposite ends and is restrained from unrolling. A plurality of bristles or tuffs is affixed to the rectangular sheet substantially along the interior surface. A tubular sheath encircles the rectangular sheet and has opposed open ends that cooperatively align with the opposite open ends of the rectangular sheet.

In general, in another aspect, an animal self-grooming device is provided. The device includes a rectangular sheet of flexible material that has an interior surface and an exterior surface. The rectangular sheet is rolled into a generally tubular-shaped enclosure that is open at opposite ends and includes a longitudinally extending seam. A plurality of bristles or tuffs is affixed to the rectangular sheet substantially along the interior surface. A first flexible securement band encircles the rectangular sheet about the exterior surface and has opposed ends that are secured to the rectangular sheet at opposite edges of the seam so as to prevent separation of the seam. A second flexible securement band encircles the rectangular sheet about the exterior surface at a spaced location from the first flexible securement band and has opposed ends secured to the rectangular sheet at opposite edges of the seam so as to prevent separation of said seam. A tubular sheath encircles the rectangular sheet and the first and second flexible securement bands. The tubular sheath has opposed open ends that cooperatively align with the opposite open ends of the rectangular sheet.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of an animal grooming device constructed in accordance with the principles of an embodiment of the present invention, showing the device in an in-use configuration secured to an article of furniture;

FIG. 2 is a top view of the animal grooming device of FIG. 1;

FIG. 3 is a perspective exploded or dissembled view of an animal grooming device constructed in accordance with the principles of an embodiment of the present invention, illustrating a rectangular and flexible sheet, a pair of securement bands, and a protective sheath;

FIG. 4 is a perspective view of an animal grooming device constructed in accordance with the principles of an embodiment of the present invention illustrated partially assembled;

FIG. 5 is a top view of the animal grooming device of FIG. 4 shown further assembled and with the protective sheath exploded.

### DETAILED DESCRIPTION OF THE INVENTION

As a preliminary matter, it should be noted that in this document (including the claims) directional terms, such as “above”, “below”, “upper”, “lower”, etc., are used for convenience in referring to the accompanying drawings. Additionally, it is to be understood that the various embodiments of the invention described herein may be utilized in various orientations, such as inclined, inverted, horizontal, vertical, etc., without departing from the principles of the invention.

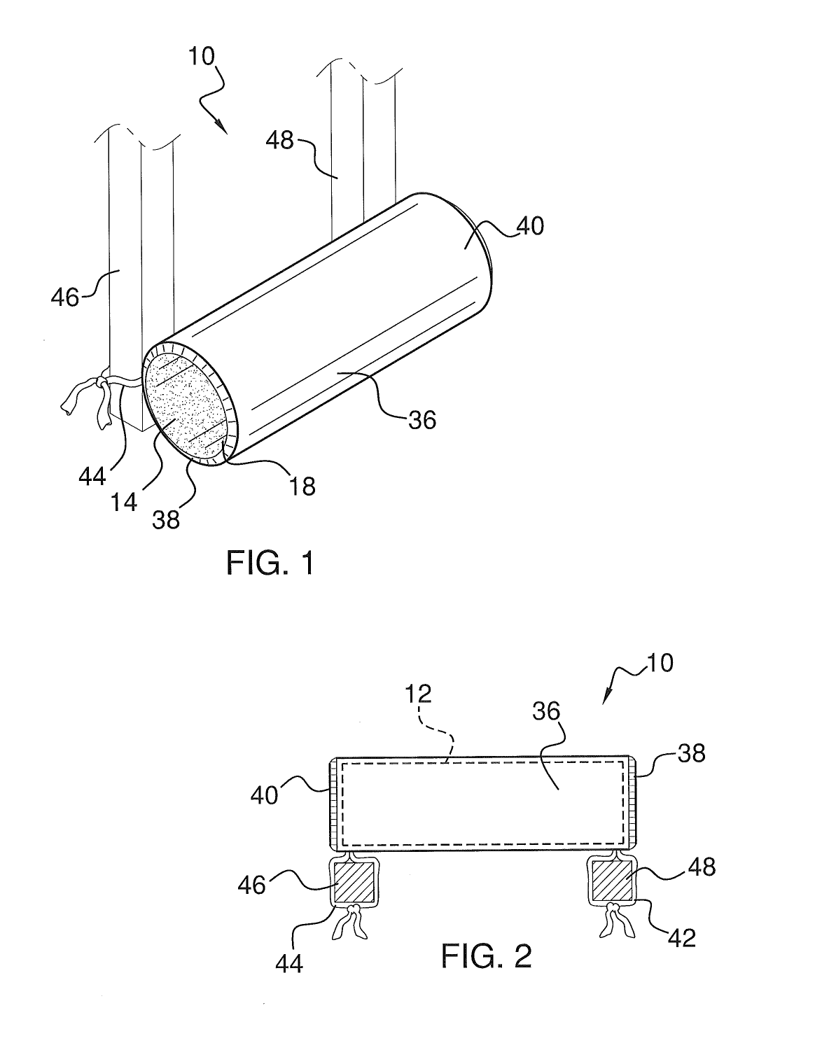

In FIGS. 1 through 5, there is representatively illustrated a specially designed animal grooming device 10 embodying principles of an embodiment of the present invention. The device includes a rectangular sheet of flexible material 12 that is rolled into a generally elongated tubular-shaped form or enclosure 13 having opposite ends 14 and 16 that are open. As will be described further below, open ends 14 and 16 permit passage of an animal through the tubular-shaped enclosure 13 from one end to the other and in either direction. The rectangular sheet of flexible material 12 has an interior surface 18 and an exterior surface 20.

A plurality of bristles or tuffs 22 are attached to the rectangular sheet 12 and substantially cover the entire interior surface 18. In embodiments, the interior surface 18 may be covered entirely will bristles or tuffs alone. And in other embodiments, the interior surface 18 may be patterned such that certain areas include bristles and other areas include tuffs. In an embodiment, the rectangular sheet is a flexible sheet of carpet material wherein the interior surface 18 may be a pile layer and the exterior surface 20 may be a backing layer.

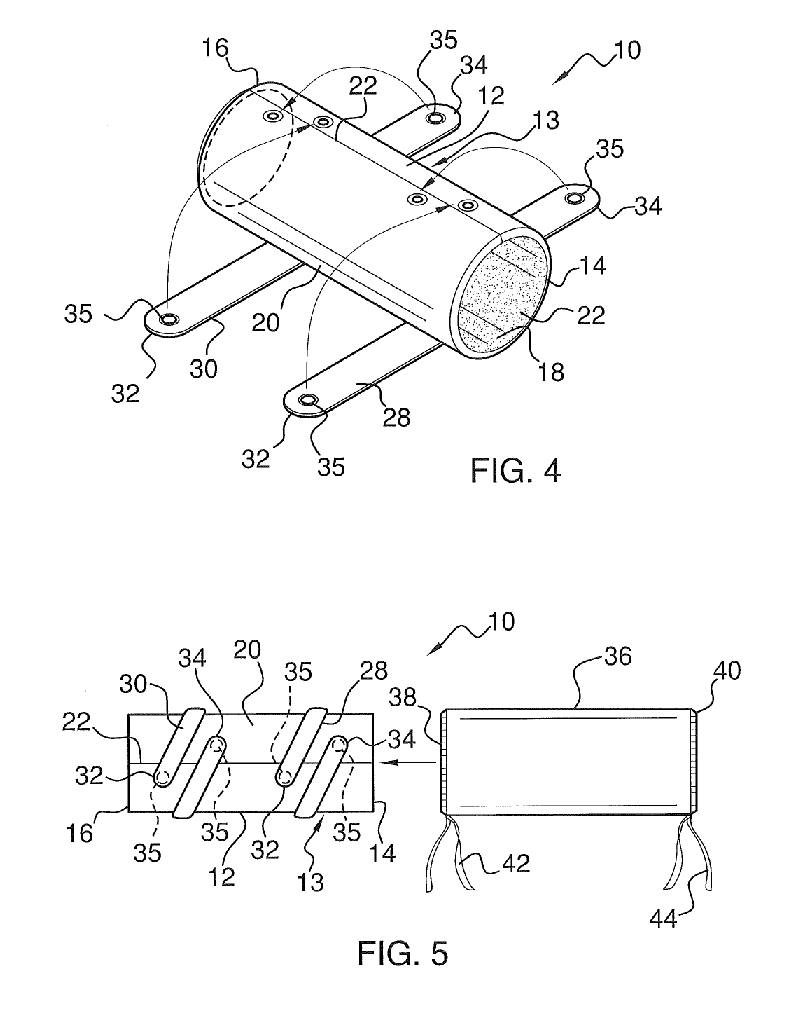

The rectangular sheet 12, once rolled into the tubular-shaped enclosure 13 a seam 22 is created by opposite edges 24 and 26 of the sheet. In the tubular-shaped form, the rectangular sheet 12 is restrained from unrolling and separating seam 22. In an embodiment a pair of flexible securement bands 28 and 30 are provided and employed to restrain or prevent unrolling of the rectangular sheet 12. Particularly, each securement band 28, 30 is an elongated band of flexible material that is wrapped around the rectangular sheet 12 (in the tubular-shaped enclosure 13 form) such that the band encircles the rectangular sheet. Opposite ends 32, 34 of the band 28, 30 are secured to the rectangular sheet 12 such that band extends across the seam 22 to prevent the seam from separating and unrolling of the rectangular sheet. Each band 28, 30 is spaced from each other along the rectangular sheet 12 to more evenly secure the rectangular sheet. In an embodiment, each band 28, 30 is secured to the rectangular sheet 12 such that ends 32, 34 are secured to opposite edges 24, 26 of the rectangular sheet as best seen in FIGS. 4 and 5. Ends 32, 34 may be secured to the rectangular sheet 12 may a number of means 35, including snaps, buttons, etc.

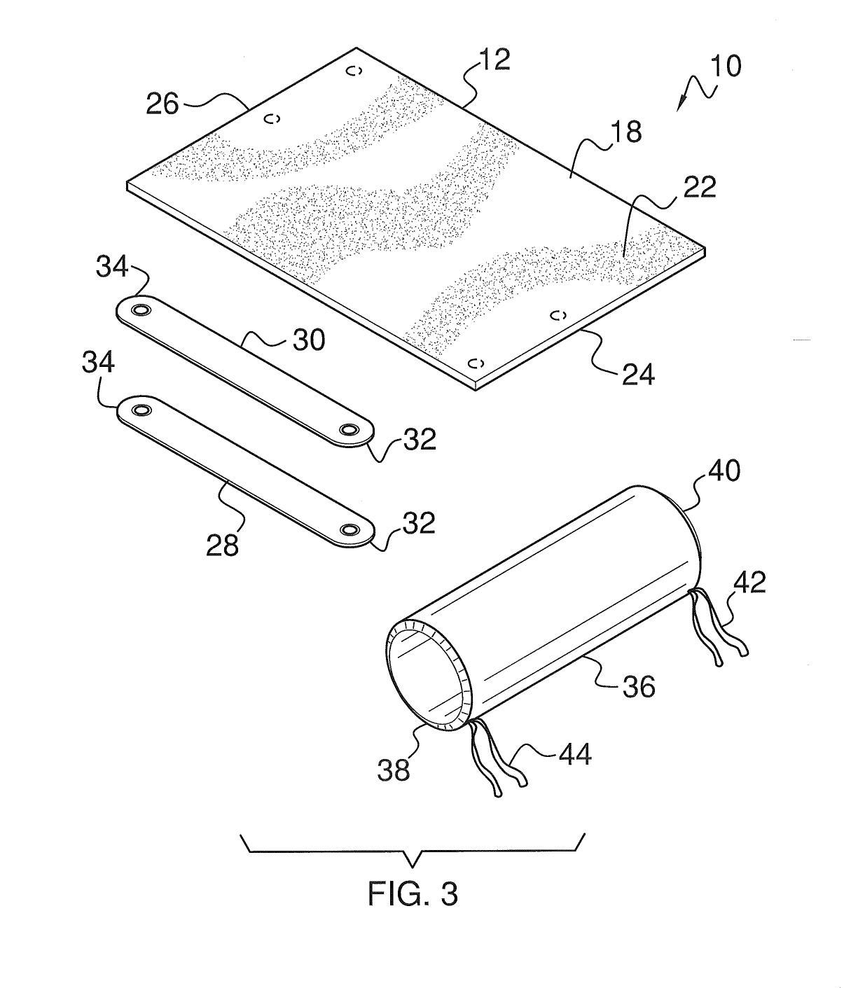

In an embodiment, bands 32, 34 are formed of a resilient, flexible material that biases the bands into a flat, open (non-circular) configuration as best seen in FIG. 3. To this end, with the bands 28, 30 wrapped around (encircling) the rectangular sheet and ends 32, 34 secured along opposite edges 24, 26, as depicted, the outwardly directed biasing force of the bands serve to prevent the tubular-enclosure 13 from collapsing inwardly.

A tubular sheath 36 is provided for covering the rectangular sheet 12 and the securement bands 28, 30 so as to protect the assembly from an animal to prevent injury to the animal as well as to guard against the animal from dislodging the securement bands. The tubular sheath 36 has opposed open ends 38 and 40 that cooperatively align with the opposite open ends 14 and 16 of said rectangular sheet 12/tubular enclosure 13. The tubular sheath 36 may be constructed of a cloth material that may have a desired decorative pattern or the like for aesthetic purposes. In an embodiment, ends 38 and 40 may be fitted with elastic cuffs to cinch down on the rectangular sheet 12.

A pair of securement ties 42 and 44 may be provided and affixed to the tubular sheath 36 to removably secure the animal grooming device 10 to spaced support structures, such as spaced legs 46 and 48 of an article of furniture, to hold the animal grooming device stationary as an animal walks through the device, as best seen in FIGS. 1 and 2.

The animal grooming device 10 may be provided in a kit or dissembled form including the rectangular sheet 12, the securement bands 28 and 30, and the tubular sheath 36 as seen in FIG. 3. When disassembled, the animal grooming device 10 may be more suitable for shipping and storage than when the animal grooming device is assembled.

In use an animal, such as a cat, would enter the tubular enclosure 13 through one end 14, 16, pass through the enclosure, and exit through the opposite end 14, 16. While the animal passes through the tubular enclosure 13 the bristles or tuffs 22 urge against the coat of the animal and dislodge and trap loose hair, dirt and debris, and/or pests, such as ticks, from the animal. Thus, the animal's natural instinct to groom is satisfied by the animal passing through the animal grooming device 10 and in turn serves to deter the animal from using undesirable furnishings for grooming itself. Additionally, the removed hair, debris and/or pests are contained in a manner that is convenient for disposal.

A number of embodiments of the present invention have been described. Nevertheless, it will be understood that various modifications may be made without departing from the spirit and scope of the invention. Accordingly, other embodiments are within the scope of the following claims.

What is claimed is:

1. An animal self-grooming device, comprising:
a rectangular sheet of flexible material having an interior surface and an exterior surface, said rectangular sheet rolled into a generally tubular-shaped enclosure that is open at opposite ends, said rectangular sheet being restrained from unrolling;
a plurality of bristles or tuffs affixed to said rectangular sheet substantially along said interior surface; and
a tubular sheath encircling said rectangular sheet and having opposed open ends cooperatively aligned with said opposite open ends of said rectangular sheet.

2. The animal self-grooming device of claim 1, further comprising:
a first and second securement ties affixed to said tubular sheath that are operative to removably secure said animal grooming device to spaced support structures.

3. An animal self-grooming device, comprising:
a rectangular sheet of flexible material having an interior surface and an exterior surface, said rectangular sheet rolled into a generally tubular-shaped enclosure that is open at opposite ends and having a longitudinally extending seam;
a plurality of bristles or tuffs affixed to said rectangular sheet substantially along said interior surface;
a first flexible securement band encircling said rectangular sheet about said exterior surface thereof and having opposed ends secured to said rectangular sheet at opposite edges of said seam so as to prevent separation of said seam;
a second flexible securement band encircling said rectangular sheet about said exterior surface thereof at a spaced location from said first flexible securement band and having opposed ends secured to said rectangular sheet at opposite edges of said seam so as to prevent separation of said seam; and
a tubular sheath encircling said rectangular sheet and said first and second flexible securement bands, said tubular sheath having opposed open ends cooperatively aligned with said opposite open ends of said rectangular sheet.

4. The animal self-grooming device of claim 1, further comprising:
a first and second securement ties affixed to said tubular sheath a first and second securement ties affixed to said tubular sheath that are operative to removably secure said animal grooming device to spaced support structures.

5. An animal self-grooming device, comprising:
a rectangular sheet of flexible carpet material having an interior surface and an exterior surface, said rectangular sheet rolled into a generally tubular-shaped enclosure that is open at opposite ends and having a longitudinally extending seam;
a plurality of tuffs affixed to said rectangular sheet substantially along said interior surface;
a first flexible securement band encircling said rectangular sheet about said exterior surface thereof and having opposed ends secured to said rectangular sheet at opposite edges of said seam so as to prevent separation of said seam;
a first flexible securement band encircling said rectangular sheet about said exterior surface thereof at a spaced location from said first flexible securement band and having opposed ends secured to said rectangular sheet at opposite edges of said seam so as to prevent separation of said seam; and
a tubular sheath encircling said rectangular sheet and said first and second flexible securement bands, said tubular sheath having opposed open ends cooperatively aligned with said opposite open ends of said rectangular sheet; and
a first and second securement ties affixed to said tubular sheath a first and second securement ties affixed to said tubular sheath that are operative to removably secure said animal grooming device to spaced support structures.
